(19) United States
(12) Patent Application Publication
(10) Pub. No.: US 2026/0360179 A1
(43) Pub. Date: Nov. 12, 2026

(54) FINGERPRINT RECOGNITION METHOD AND ELECTRONIC DEVICE CONFIGURED TO PERFORM SAME

(71) Applicant: SAMSUNG ELECTRONICS CO., LTD., Suwon-si (KR)

(72) Inventors: Youngbae JEON, Suwon-si (KR); Jungil CHO, Suwon-si (KR); Moongyu JUNG, Suwon-si (KR); Joonghwan LEE, Suwon-si (KR); Jongsung LEE, Suwon-si (KR); Jaewoo SEO, Suwon-si (KR); Iljoo KIM, Suwon-si (KR); Bumjun KWON, Suwon-si (KR)

(21) Appl. No.: 19/706,484

(22) Filed: Jun. 12, 2026

Related U.S. Application Data
(63) Continuation of application No. PCT/KR2026/096292, filed on Apr. 24, 2026.

(30) Foreign Application Priority Data
May 9, 2025 (KR) 10-2025-006081

(51) Int. Cl. G06V 40/12; G06V 10/762

(52) U.S. Cl. CPC G06V 40/1376; G06V 10/7625; G06V 40/1335; G06V 40/1371

(57) ABSTRACT

A fingerprint recognition method performed by an electronic device includes: obtaining a fingerprint image, estimating ridges of a fingerprint represented by the fingerprint image by tracking ridge paths from one or more start points within the fingerprint image through a ridge estimation algorithm, and obtaining fingerprint information for fingerprint recognition based on the estimated ridges, wherein, for each of the ridges of the fingerprint, the ridge estimation algorithm may perform predicting a next point of a ridge path based on a current point and motion state parameters, adjusting the predicted next point and updating the motion state parameters based on the predicted next point and pixel values of the fingerprint image, and identifying a single ridge by tracking the ridge path through repeated prediction and adjustment of subsequent points of the ridge path.

### CROSS-REFERENCE TO RELATED APPLICATIONS

This application is a continuation of International Application No. PCT/KR 2026/096292 designating the United States, filed on Apr. 24, 2026, in the Korean Ministry of Intellectual Property Receiving Office and claiming priority to Korean Patent Application No. 10-2025-0060681, filed on May 9, 2025, in the Korean Ministry of Intellectual Property, the disclosures of each of which are incorporated by reference herein in their entireties.

### BACKGROUND

### Field

The disclosure relates to a fingerprint recognition method by which fingerprint information is generated from a fingerprint image and fingerprint recognition is performed, and an electronic device configured to perform fingerprint recognition.

### Description of Related Art

Fingerprint recognition refers to a biometric technology that performs user authentication by scanning and analyzing a user's fingerprint on an electronic device. Fingerprint recognition is utilized across a wide range of devices, including smartphones, tablets, laptops, and access control systems, serving as a core feature that provides security, convenience, and a personalized experience. When using fingerprint recognition, ridge defects may occur due to factors such as dry skin or scars on a user's finger, which may result in cases in which fingerprint information is undetected or incorrectly detected. To address this, various algorithms are being applied to enhance fingerprint visibility; however, it is essential to provide robust fingerprint recognition results regardless of the condition of the finger.

### SUMMARY

According to an example embodiment of the disclosure, provided is a fingerprint recognition method performed by an electronic device. The method may include: obtaining a fingerprint image, estimating ridges of a fingerprint represented by the fingerprint image by tracking ridge paths from one or more start points within the fingerprint image through a ridge estimation algorithm, and obtaining fingerprint information for fingerprint recognition, based on the estimated ridges. For each of the ridges of the fingerprint, the ridge estimation algorithm may perform predicting a next point of a ridge path, based on a current point and motion state parameters, adjusting the predicted next point and updating the motion state parameters, based on the predicted next point and pixel values of the fingerprint image, and identifying a single ridge by tracking the ridge path through repeated prediction and adjustment of subsequent points of the ridge path.

According to an example embodiment of the disclosure, provided is an electronic device configured to perform fingerprint recognition. The electronic device may include at least one processor, comprising processing circuitry, memory storing instructions, and a display.

The instructions, when executed by at least one processor, individually or in any combination, may cause the electronic device to: obtain a fingerprint image, estimate ridges of a fingerprint represented by the fingerprint image, by tracking ridge paths from one or more start points within the fingerprint image through a ridge estimation algorithm, and obtain fingerprint information for fingerprint recognition, based on the estimated ridges. For each of the ridges of the fingerprint, the ridge estimation algorithm may perform predicting a next point of a ridge path, based on a current point and motion state parameters, adjusting the predicted next point and updating the motion state parameters, based on the predicted next point and pixel values of the fingerprint image, and identifying a single ridge by tracking the ridge path through repeated prediction and adjustment of subsequent points of the ridge path.

According to an example embodiment of the disclosure, provided is a non-transitory computer-readable recording medium having recorded thereon a program for executing any one of the methods of performing, by the electronic device, fingerprint recognition by generating fingerprint information from a fingerprint image, described above or to be described in greater detail below.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example fingerprint recognition operation performed by an electronic device according to various example embodiments.

FIG. 2 is a diagram illustrating various examples of a fingerprint image obtained according to a condition of a finger according to various example embodiments.

FIG. 3 is a block diagram illustrating an example configuration of an electronic device according to various example embodiments.

FIG. 4 is a diagram illustrating example errors that may occur in a general fingerprint recognition method.

FIG. 5 is a flowchart illustrating example operations of a fingerprint recognition model according to various example embodiments.

FIG. 6 is a diagram including graphs illustrating an example operation of estimating a ridge thickness of a fingerprint, performed by an electronic device according to various example embodiments.

FIG. 7 is a diagram illustrating an example fingerprint recognition model according to various example embodiments.

FIG. 8 is a diagram illustrating example motion state parameters used by an electronic device for fingerprint recognition, according to various example embodiments.

FIG. 9 is a diagram illustrating an example operation of tracking a ridge path, performed by an electronic device according to various example embodiments.

FIG. 10A is a diagram illustrating an example operation of predicting a point of a ridge path, performed by an electronic device according to various example embodiments.

FIG. 10B is a diagram illustrating an example operation of inspecting and adjusting a predicted point of a ridge path, performed by an electronic device according to various example embodiments.

FIG. 11 is a diagram illustrating an example operation of predicting a point of a ridge path, performed by an electronic device according to various example embodiments.

FIG. 12 is a diagram illustrating an example operation of determining an end point of a ridge path, performed by an electronic device according to various example embodiments.

FIG. 13 is a diagram illustrating an example operation of determining an end point of a ridge path, performed by an electronic device according to various example embodiments.

FIG. 14 is a diagram illustrating an example operation of determining start points for tracking a ridge path, performed by an electronic device according to various example embodiments.

FIG. 15 is a diagram illustrating an example operation of optimizing a connection between ridges, performed by an electronic device according to various example embodiments.

FIG. 16 is a diagram illustrating an example operation of optimizing a connection between ridges, performed by an electronic device according to various example embodiments.

FIG. 17 is a diagram illustrating an example operation of estimating a fingerprint scar, performed by an electronic device according to various example embodiments.

FIG. 18 is a diagram illustrating an example operation of performing fingerprint recognition, performed by an electronic device according to various example embodiments.

FIG. 19 is a diagram illustrating an example operation of performing fingerprint recognition, performed by an electronic device according to various example embodiments.

### DETAILED DESCRIPTION

The terms used in the disclosure are now briefly explained, followed by a detailed description of various example embodiments of the disclosure. Throughout the disclosure, the expression “at least one of a, b or c” indicates only a, only b, only c, both a and b, both a and c, both b and c, all of a, b, and c, or variations thereof.

General terms which are currently used widely have been selected for use in consideration of their functions in the disclosure; however, such terms may be changed according to an intention of a person of skill in the art, precedents, advent of new technologies, etc. In certain cases, some terms may be arbitrarily select, and in such cases, meanings of the terms will be described in detail in corresponding sections of the disclosure. Accordingly, the terms used in the disclosure should be defined based on their meanings and overall descriptions of the disclosure, not simply by their names.

An expression used in the singular encompasses the expression of the plural, unless it has a clearly different meaning in the context. The terms used herein, including technical or scientific terms, may have the same meaning as commonly understood by one of ordinary skill in the art. While such terms as “first,” “second,” etc., may be used to describe various components, such components must not be limited to the above terms. The above terms are used only to distinguish one component from another.

In the disclosure, when a portion “includes” an element, another element may be further included, rather than excluding the existence of the other element, unless otherwise described. In addition, the terms “-er”, “-or”, and “module” described in the disclosure may refer, for example, to units for processing at least one function and operation and can be implemented by hardware components or software components and combinations thereof.

Hereinafter, the disclosure will be described in greater detail with reference to the accompanying drawings. However, the disclosure may be implemented in various different forms and is not limited to embodiments described herein. In the drawings, parts irrelevant to the description may be omitted to clearly explain the disclosure. Throughout the disclosure, different reference numerals may be used for the same components for convenience of description.

The disclosure will now be described more fully with reference to the accompanying drawings.

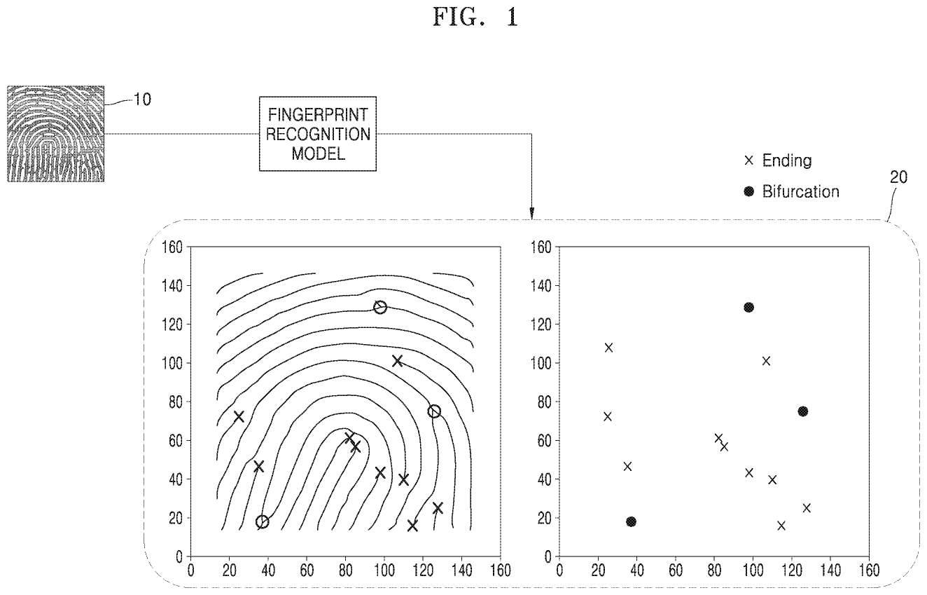

FIG. 1 is a diagram illustrating an example fingerprint recognition operation performed by an electronic device according to various example embodiments.

In an embodiment of the disclosure, an electronic device may generate fingerprint information 20 based on a fingerprint image 10. In the example illustrated in FIG. 1, the fingerprint information 20 may not correspond to the fingerprint image 10 and may be extracted from any sample fingerprint image.

The electronic device may obtain the fingerprint information 20 using a fingerprint recognition model using, for example, a ridge estimation algorithm. The fingerprint information 20 may be minutiae including specific characteristics of a fingerprint. The minutiae may include, for example, a bifurcation at which one ridge divides into two branches, an ending at which a ridge ends, etc. However, the features included in the fingerprint information 20 are not limited thereto, and the fingerprint information 20 may further include a scar, an island, a pore, a crossing, a ridge joint, etc.

The fingerprint recognition model may include a hidden Markov model (HMM)-based Kalman filter. However, the disclosure is not limited thereto. The fingerprint recognition model may estimate a plurality of ridges included in a fingerprint by tracking ridge paths from one or more start points in a fingerprint image. The fingerprint recognition model may estimate the plurality of ridges by repeating the process of estimating a single ridge in the fingerprint image. In the process of estimating a single ridge, the fingerprint recognition model may predict a next point of the ridge path based on the current point and motion state parameters. An initial point where the single ridge estimation begins may be referred to as a start point. The fingerprint recognition model may identify whether an observed actual point (pixel) is present in a fingerprint image based on the predicted next point. When the point identified, the fingerprint recognition model may predict subsequent points within a single ridge by adjusting a position of the next point or skipping the adjustment of the position of the next point. The fingerprint recognition model may determine a single ridge in the fingerprint image by repeating the process of predicting subsequent points and determining an end point of the single ridge based on whether defined conditions are satisfied. A plurality of ridges in the fingerprint image may be identified by repeating the determination of a single ridge.

The electronic device according to the disclosure may be implemented as various types of devices configured to provide the fingerprint recognition function. For example, the electronic device may include devices capable of performing biometric authentication and executing security functions through fingerprint recognition with a fingerprint sensor, such as, without limitation, a smart television (TV) with a display, a smartphone, a tablet personal computer (PC), a laptop PC, a smart signage, etc.

Various example operations of recognizing a fingerprint by the electronic device are to be described in greater detail with reference to the drawings.

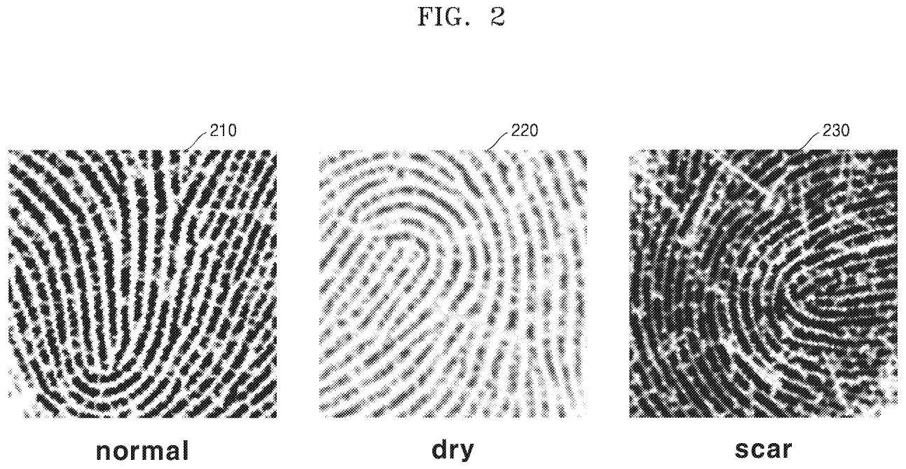

FIG. 2 is a diagram illustrating various examples of a fingerprint image obtained according to a condition of a finger.

Fingerprint recognition may be performed by detecting patterns of ridges and valleys in a fingerprint. However, the performance of fingerprint recognition may vary depending on the condition of the finger, such as dryness, scars, or moisture. FIG. 2 illustrates examples of obtained fingerprint images under various finger conditions.

A normal fingerprint image 210 may show a fingerprint obtained under normal finger conditions. The normal fingerprint image 210 may have clearly distinguished ridges and valleys with minimal noise. The normal fingerprint image 210 may be taken under conditions where appropriate moisture is maintained on the skin surface and may be characterized by uniform pixel contrast. When the fingerprint recognition is performed using the normal fingerprint image 210, clear fingerprint patterns may be detected, which leads to high recognition accuracy in final results.

A dry fingerprint image 220 may refer to a fingerprint obtained when the skin of the finger is dry. When the skin of the finger is dry, the contact between the finger and the fingerprint sensor may be imperfect, resulting in weak sensing signals. For example, the dry fingerprint image 220 may be an image where the fingerprint appears faint due to poor pixel contrast between the ridges and valleys. In the dry fingerprint image 220, ridges may appear partially broken or incomplete. Accordingly, when the fingerprint recognition is performed using the dry fingerprint image 220, the fingerprint recognition accuracy may decrease.

A scarred fingerprint image 230 may be a fingerprint obtained from a finger with temporarily or permanently damaged skin. Apart from the skin damage, the scarred fingerprint image 230 may include patterns such as fine creases or folds occurring in areas where the finger is frequently bent or under pressure. In the scarred fingerprint image 230, normal ridge patterns in the scarred area may disappear, and the scar may be incorrectly identified as a valley rather than a ridge, leading to a mismatch with the original fingerprint. As the scarred fingerprint image 230 includes discontinued ridges or abnormal spaces between ridges, the fingerprint recognition accuracy may be lowered.

In a fingerprint recognition method performed by an electronic device 100 according to the disclosure, fingerprint recognition is performed by robustly generating fingerprint information regardless of finger conditions, such as normal, dry, or scarred states, or the like. The electronic device 100 may generate precise fingerprint information using the ridge estimation algorithm to connect and restore missing or broken ridges and estimate scar information utilized for recognition.

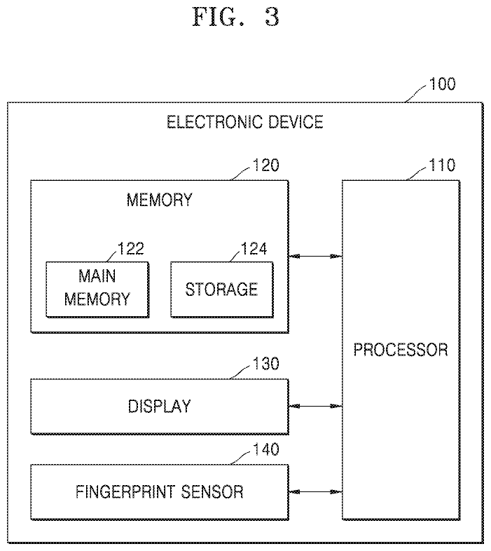

FIG. 3 is a block diagram illustrating an example configuration of an electronic device according to various example embodiments.

Referring to FIG. 3, the electronic device 100 according to an embodiment of the disclosure may include a processor (e.g., including processing circuitry) 110, memory 120, and a display 130.

The processor 110 may include various processing circuitry and control operations of the electronic device 100. By executing one or more instructions of a program stored in the memory 120 of the electronic device 100, the processor 110 may control all operations for the electronic device 100 to estimate ridges in the fingerprint image and generate fingerprint information. For example, the processor 110 may handle various tasks including arithmetic and logical operations for processes running on the electronic device 100, management of main memory 122, and data transfer with a storage 124.

The processor 110 may include a processing circuitry. The processing circuitry may include an arithmetic and logic unit for performing arithmetic and logical operations, a control unit for interpreting commands and controlling execution, and registers and cache memory for storing data. However, the disclosure is not limited thereto.

The processor 110 may include, for example, at least one of, a central processing unit (CPU), a microprocessor, a graphics processing unit (GPU), application specific integrated circuits (ASICs), digital signal processors (DSPs), digital signal processing devices (DSPDs), programmable logic devices (PLDs), field programmable gate arrays (FPGAs), an application processor (AP), a neural processing unit (NPU), or an artificial intelligence (AI)-dedicated processor designed with a hardware structure specialized for processing AI models. However, the disclosure is not limited thereto.

In an embodiment of the disclosure, the processor 110 may include one or more processors. When the processor 110 includes one or more processors, the operations according to the disclosure may be performed by executing the instructions and/or program stored in the memory 120 by the one or more processors individually or collectively in any combination. When the method according to an embodiment of the disclosure includes a plurality of operations, the plurality of operations may be performed by one processor 110 or by a plurality of processors 110.

For example, when the method according to an embodiment of the disclosure is performed in the electronic device 100, a first operation, a second operation, and a third operation may all be performed by a first processor, or some of the first to third operations may be performed by the first processor for handling general-purpose tasks, while the remaining operations may be performed by a second processor for handling machine learning-related tasks. However, the disclosure is not limited thereto.

The one or more processors 110 according to the disclosure may be implemented as a single-core processor or a multi-core processor. When the method according to an embodiment of the disclosure includes a plurality of operations, the plurality of operations may be performed by a single core or by a plurality of cores included in the one or more processors 110.

Various example operations of the electronic device 100 that are performed by the processor 110 are to be described in greater detail below with reference to the drawings.

The memory 120 may store data processed in the electronic device 100.

The memory 120 may include the main memory 122 storing data that is currently processed in the electronic device 100. The main memory 122 may store data and a program executed by the processor 110 such that the processor 110 may rapidly access the data. The main memory 122 may include, for example, volatile memory such as random-access memory (RAM) or static RAM (SRAM). However, the disclosure is not limited thereto.

The memory 120 may include the storage 124 permanently storing large-scale data, such as programs, applications, system files, and media files. The storage 124 may include, for example, non-volatile memory including at least one of a hard disk drive (HDD), a solid state drive (SSD), an optical drive (e.g., CD), a flash drive, read-only memory (ROM), electrically erasable programmable ROM (EEPROM), or programmable ROM (PROM). However, the disclosure is not limited thereto.

The display 130 may output an image signal on a screen of the electronic device 100 according to a control by the processor 110. For example, the display 130 may display a graphic interface that guides a fingerprint input for fingerprint recognition and output on the screen an image signal representing security functions (e.g., secure content) provided to an authenticated user upon successful fingerprint recognition.

The display 130 may include a touch panel. The touch panel may include one or more touch sensors sensing a touch input. In an embodiment of the disclosure, a user input for interacting with the electronic device 100 may be obtained through the touch panel.

A fingerprint sensor 140 may include, for example, and without limitation, a capacitive fingerprint sensor, an optical fingerprint sensor, an ultrasonic fingerprint sensor, etc. However, the disclosure is not limited thereto. The fingerprint sensor 140 may be arranged at positions such as a home button, a power button, or the front or rear surface of the electronic device 100 to sense a contact with a user's finger and obtain a fingerprint image. In an embodiment of the disclosure, the fingerprint sensor 140 may be embedded in the display 130. In this case, the fingerprint sensor 140 may sense a contact of a user's finger on the screen of the display 130 and obtain a fingerprint image.

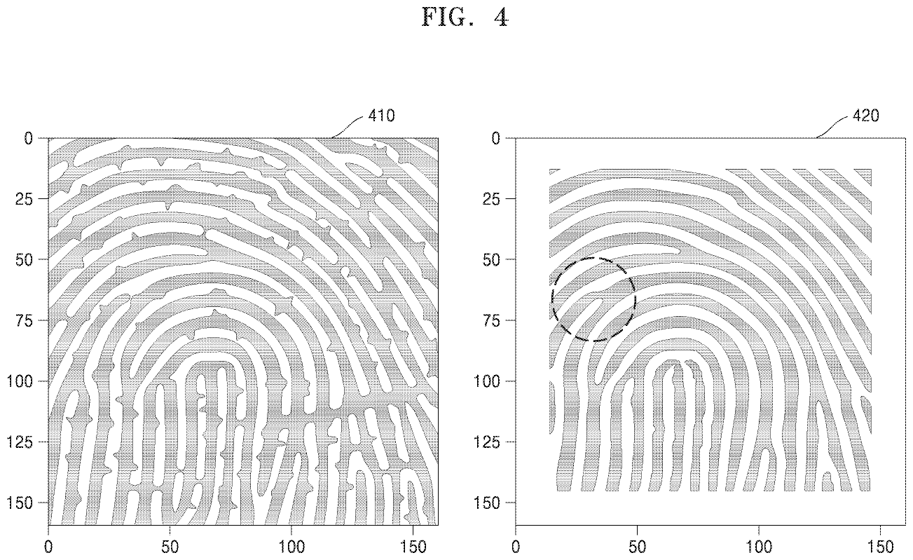

FIG. 4 is a diagram illustrating example errors that may occur in a general fingerprint recognition method.

A general fingerprint recognition method may include a process of generating an enhanced fingerprint image 420 based on a fingerprint image 410 and generating fingerprint information from the enhanced fingerprint image 420.

For example, in the general fingerprint recognition method, the fingerprint image 410 may be normalized, and filtering (e.g., Gabor filter) may be applied thereto in multiple different directions to emphasize ridges of the fingerprint. The image may be binarized to enhance the contrast between ridges and valleys, thereby generating the enhanced fingerprint image 420. In the general fingerprint recognition method, the enhanced fingerprint image 420 may be thinned to reduce the ridge width, and unique features (e.g., bifurcations and endings) may be analyzed to generate fingerprint information (minutiae).

However, in the general fingerprint recognition method, recognition may be smoothly performed on the fingerprint image 410 under normal finger conditions; however, when the finger is dry or includes a scar, inaccurate fingerprint information may be generated. Referring to FIG. 4, in the general fingerprint recognition method, when the enhanced fingerprint image 420 is generated based on the fingerprint image 410, a bifurcation, which is actually a split in the ridge may appear as a ridge ending.

In the fingerprint recognition method performed by the electronic device 100 according to various example embodiments of the disclosure, fingerprint recognition is performed by robustly generating fingerprint information regardless of finger conditions, such as normal, dry, or scarred states. The electronic device 100 may generate precise fingerprint information using the ridge estimation algorithm to connect and restore missing or broken ridges and estimate scar information utilized for recognition. Hereinafter, operations of the fingerprint recognition method according to the disclosure that are different from those of the general fingerprint recognition method are described.

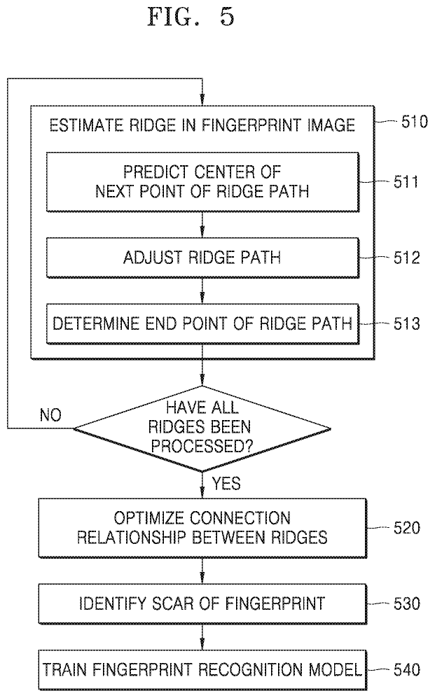

FIG. 5 is a flowchart for illustrating example operations of a fingerprint recognition model according to various example embodiments.

In an embodiment of the disclosure, the electronic device 100 may obtain fingerprint information using a fingerprint recognition model. The fingerprint recognition model may estimate ridges of a fingerprint using a ridge estimation algorithm. The fingerprint recognition model may include an HMM-based Kalman filter. However, the disclosure is not limited thereto.

In operation 510, the electronic device 100 may estimate ridges by obtaining a fingerprint image and estimating ridge paths in the fingerprint image. The electronic device 100 may estimate a plurality of ridges of the fingerprint by repeating the process of identifying a single ridge included in the fingerprint. For example, the electronic device 100 may identify a first single ridge by tracking a ridge path from a first start point and identify a second single ridge by tracking a ridge path from a second start point. In this case, the first single ridge and the second single ridge may be any one of the plurality of ridges included in the fingerprint within the fingerprint image. The electronic device 100 may identify a single ridge by repeating operations 511, 512 and 513. The electronic device 100 may identify a single ridge by repeating a process of predicting a next point based on a current point, starting from a start point, and determining an end point.

In operation 511, the electronic device 100 may predict a center of the next point on the ridge path. The electronic device 100 may predict the next point on the ridge path based on the current point (e.g., start point) and motion state parameters corresponding to the current point. The motion state parameters may include, for example, velocity and acceleration.

In operation 512, the electronic device 100 may adjust the ridge path by adjusting a position of the predicted point. The electronic device 100 may adjust the position of the predicted point based on pixel values of the fingerprint image. The pixel values of the fingerprint image may have higher values (e.g., 255) as they represent ridges, and lower values (e.g., 0) as they represent valleys. The electronic device 100 may adjust the position of the predicted point and update the motion state parameters. In an embodiment of the disclosure, when a pixel representing a ridge is not identified in a predetermined range from the predicted next point, the electronic device 100 may skip the adjustment of the position of the predicted point.

In operation 513, the electronic device 100 may determine an end point of a single ridge path. The electronic device 100 may determine the end point of the ridge path based on defined conditions. When the current point is not determined as the end point of a single ridge path, the electronic device 100 may repeat operations 511 to 513 such that the prediction and adjustment for subsequent points of the ridge path are continuously performed.

The defined conditions may include, for example, and without limitation, a case where it is determined that the ridge path no longer exists because the next point is not identified, a case where the predicted next point is determined to be a point on a different ridge path rather than the current ridge path being tracked, etc. When the end point of the single ridge is determined, the electronic device 100 may update a path tracking state (e.g., termination of path tracking). When the end point of the single ridge is determined, the electronic device 100 may track a path of another single ridge, starting from another start point. To track another single ridge path from another start point, the electronic device 100 may repeat operations 511, 512 and 513.

In operation 520, the electronic device 100 may optimize the connection relationships between the plurality of ridges identified through operation 510. For example, the electronic device 100 may optimize the connection relationships between the ridges through maximum likelihood estimation. The process of optimizing the connection relationships between the plurality of ridges by the electronic device 100 is to be further described in greater detail below with reference to the drawings.

In operation 530, the electronic device 100 may identify one or more scars of a fingerprint in the fingerprint image. The identified scars may be included in the fingerprint information, or a fingerprint from which the identified scars have been removed may be stored as the fingerprint information by the electronic device 100.

In operation 540, the electronic device 100 may train the fingerprint recognition model. During each single ridge estimation process, the fingerprint recognition model may predict a next point based on the motion state parameters. The motion state parameters used in prediction may include velocity and acceleration and may be treated as hidden parameters. Based on the data obtained from the aforementioned operations for fingerprint recognition, the electronic device 100 may learn related probability parameters such that the fingerprint recognition model may infer observed values (e.g., pixel values of a fingerprint image) based on the hidden parameters.

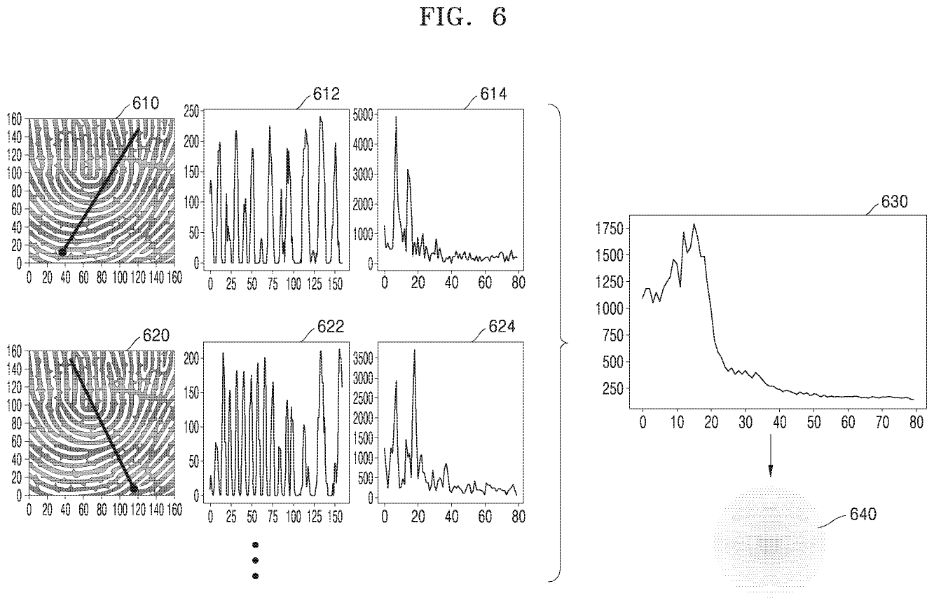

FIG. 6 is a diagram including various graphs illustrating an example operation of estimating a ridge thickness of a fingerprint by an electronic device according to various example embodiments.

In an embodiment of the disclosure, the electronic device 100 may estimate an average thickness of ridges in a fingerprint. To estimate the average thickness of the ridges in the fingerprint, the electronic device 100 may generate an arbitrary line crossing the fingerprint image. The electronic device 100 may generate brightness data representing brightness versus pixel distance by generating an arbitrary line crossing the fingerprint image. In this case, in the brightness data, a relatively large brightness (pixel value) may represent a ridge, and a relatively small brightness may represent a valley. The electronic device 100 may generate frequency data representing intensity versus frequency by converting the brightness data into a frequency domain.

For example, as shown in a first example 610, the electronic device 100 may generate a first line crossing the fingerprint image. By identifying pixel values of the fingerprint image along the first line, the electronic device 100 may generate first brightness data 612 representing brightness versus pixel distance and generate first frequency data 614 representing intensity versus frequency through Fourier transform.

As shown in a second example 620, the electronic device 100 may generate a second line crossing the fingerprint image. By identifying pixel values of the fingerprint image along the second line, the electronic device 100 may generate second brightness data 622 representing brightness versus pixel distance and generate second frequency data 624 representing intensity versus frequency through Fourier transform.

In a similar manner, the electronic device 100 may generate arbitrary lines crossing the fingerprint image in a plurality of directions, measure pixel values, and perform transformation into the frequency domain to obtain frequency data in each direction. For example, the electronic device 100 may generate 36 lines rotating at intervals of 10 degrees to perform pixel value measurement and transformation into the frequency domain. However, the disclosure is not limited thereto.

In an embodiment of the disclosure, the electronic device 100 may obtain average frequency data 630. For example, the electronic device 100 may calculate an average based on the first frequency data 614, the second frequency data 624, . . . , and Nth frequency data. The electronic device 100 may estimate the thickness of a ridge in the fingerprint image using the average frequency data 630. For example, the electronic device 100 may identify frequency values within a predetermined range having high intensity in the average frequency data. As frequency and period have an inverse relationship, the electronic device 100 may identify the period based on the frequency values and determine the thickness of the ridges appearing periodically within the fingerprint image in units of pixels.

In an embodiment of the disclosure, the electronic device 100 may track a ridge path based on a ridge thickness. For example, the electronic device 100 may adjust a radius of a Gaussian function 640 for ridge path tracking and adjustment to correspond to the estimated ridge thickness. The radius of the Gaussian function 640 may be adjusted the variance, and the electronic device 100 may adjust the variance of the Gaussian function based on the ridge thickness.

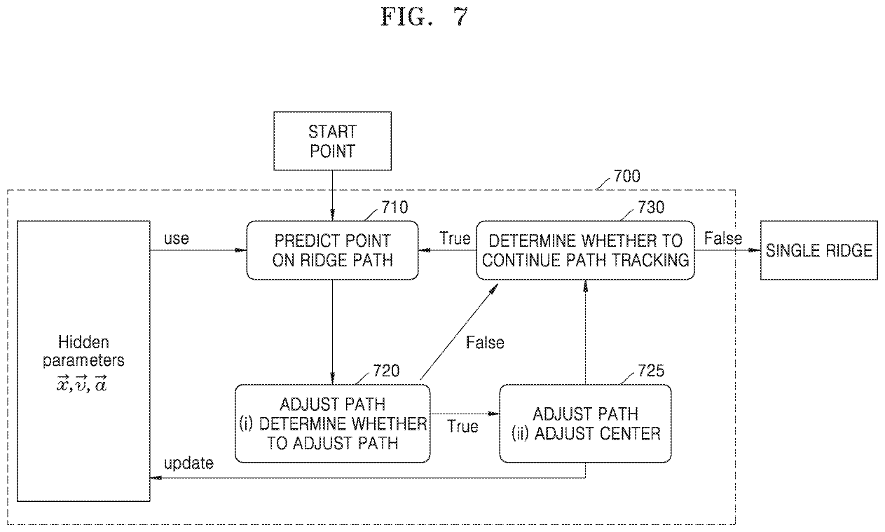

FIG. 7 is a diagram illustrating an example fingerprint recognition model according to various example embodiments.

In an embodiment of the disclosure, the electronic device 100 may obtain fingerprint information using a fingerprint recognition model 700. The fingerprint recognition model 700 may include an HMM-based Kalman filter. The HMM-based Kalman filter may be designed to estimate a next state from a previous state and correct an estimated value based on observed values, and may obtain fingerprint recognition information by tracking each single ridge in the fingerprint image to identify a plurality of ridges.

The fingerprint recognition model 700 may include velocity and acceleration as hidden parameters.

The fingerprint recognition model 700 may repeat the process of estimating and correcting points on a ridge path along the ridge path from a start point.

In operation 710, the fingerprint recognition model 700 may predict a point on a ridge path. The fingerprint recognition model 700 may predict a next point based on a position of the current point as well as the velocity and acceleration included in the motion state parameters. The initial position may be a start point, and the initial velocity and acceleration may have arbitrary values or preset values.

In operation 720, the fingerprint recognition model 700 may adjust a path based on the next point predicted from the current point. A first operation of a process included in the path adjustment may be a process of determining whether path adjustment is necessary, which is a process of determining whether the predicted next point corresponds to an observed value. This involves identifying whether a point predicted to be on the ridge path exists, and may also be referred to as a point identification process. The fingerprint recognition model 700 may repeat the process of predicting a point, and as such repetition is performed to predict a next point based on the current point, in the disclosure, a “predicted next point” may also be simply referred to as a “predicted point.” The fingerprint recognition model 700 may use pixel values in the fingerprint image to verify whether the predicted point corresponds to the observed value. In the fingerprint image, the pixel values may have higher values (e.g., 255) as they represent ridges, and lower values (e.g., 0) as they represent valleys.

The fingerprint recognition model 700 may use, for example, the maximum likelihood estimation. The fingerprint recognition model 700 may calculate a likelihood representing a probability that the observed data occurs, based on pixel values which are a set of observed data representing ridges. For example, the fingerprint recognition model 700 may calculate likelihood values for a predetermined range from the predicted point. The fingerprint recognition model 700 may identify the values of position, velocity, and acceleration, which are hidden parameters that maximize and/or increase the likelihood values. When the likelihood values calculated during the maximum likelihood estimation are less than a threshold value, the fingerprint recognition model 700 may skip operation 725 (described below) which is an operation of adjusting a position of a predicted next point such that operation 730 which is an operation of determining whether to continue ridge path tracking is performed. When the likelihood values are greater than or equal to the threshold value during the maximum likelihood estimation, the fingerprint recognition model 700 may identify hidden parameters that yield the maximum likelihood among the likelihood values that are greater than or equal to the threshold value. The fingerprint recognition model 700 may select hidden parameters that yield the maximum likelihood and then perform operation 725.

In operation 725, the fingerprint recognition model 700 may adjust the path based on the predicted point. The second operation of the process included in the path adjustment process may, for example, be center adjustment. When the hidden parameters that yield the maximum likelihood (e.g., position, velocity, and acceleration) are identified, the fingerprint recognition model 700 may adjust the position of the predicted point to the identified position and update the hidden parameters. When the hidden parameters are updated, the fingerprint recognition model 700 may perform operation 730 which determines whether to continue the ridge path tracking.

In operation 730, the fingerprint recognition model 700 may determine whether to continue the path tracking. The fingerprint recognition model 700 may update the path tracking state based on the defined conditions.

For example, the fingerprint recognition model 700 may examine a first condition indicating whether the point prediction and adjustment have been performed through operation 720 and 725.

For example, when both operation 720 and operation 725 have been performed (first condition is satisfied), the fingerprint recognition model 700 may examine a second condition.

As the fingerprint recognition model 700 repeats the process of identifying a single ridge, one or more identified single ridges may already exist. Accordingly, the second condition may be to see whether the predicted and adjusted point is a point on the current ridge path (e.g., the point should not be a point on a different ridge path).

When the predicted and adjusted point is a point on the current ridge path and not a point on a different ridge path (second condition is satisfied), the fingerprint recognition model 700 may maintain the path tracking state as “continue path tracking” to continue the path tracking. When the path tracking state is “continue path tracking,” the fingerprint recognition model 700 may predict a next point on the ridge path by re-performing operation 710.

When the predicted and adjusted point is identified as a point on a different ridge path (second condition is not satisfied), the predicted and adjusted point is a point on a ridge path rather than a point on the ridge path that is currently tracked. The fingerprint recognition model 700 may update the path tracking state as “terminate path tracking.” In this case, a point prior to the last predicted and adjusted point may be determined as an end point of the ridge path. The fingerprint recognition model 700 may identify the path including points from the start point to the end point of the ridge path as a single ridge path.

For example, when operation 720 is performed, and operation 725 is not performed (first condition is not satisfied), the fingerprint recognition model 700 may examine a third condition.

During the process of identifying a single ridge by the fingerprint recognition model 700, due to the degradation of fingerprint image quality, some ridges may be missing even though the fingerprint ridges actually exist. Accordingly, the third condition may be to reflect whether the number of times point adjustment has been skipped is less than a preset number of times to reflect a case where point prediction has been performed but point adjustment has not been performed due to omission of an observed value. The preset (e.g., specified) number may be, for example, 4. However, the disclosure is not limited thereto.

For example, when there is a point that has been predicted but not adjusted (e.g., skipped point), the fingerprint recognition model 700 may maintain the path tracking state as “continue path tracking” to continue the path tracking. When the path tracking state is “continue path tracking,” the fingerprint recognition model 700 may predict a subsequent point on the ridge path by re-performing operation 710.

When the number of times point adjustment has been skipped is less than the preset number of times (third condition is satisfied), the fingerprint recognition model 700 may maintain the path tracking state as “continue path tracking” to continue the path tracking. When the number of times point adjustment has reached the preset number of times (third condition is not satisfied), the fingerprint recognition model 700 may update the path tracking state to “terminate path tracking.” In this case, a point prior to the last predicted point may be determined as an end point of the ridge path. The fingerprint recognition model 700 may identify the path including points from the start point to the end point of the ridge path as a single ridge path.

The fingerprint recognition model 700 may identify a plurality of ridges included in a fingerprint by repeating the process of identifying a single ridge from different start points. The electronic device 100 may obtain the fingerprint information for fingerprint recognition based on the plurality of ridges identified using the fingerprint recognition model 700. The fingerprint information may be minutiae including specific characteristics of a fingerprint. The minutiae may include, for example, a bifurcation at which one ridge divides into two branches, an ending at which a ridge ends, etc. However, the disclosure is not limited thereto, and the minutiae may also include a scar, an island, a pore, a crossing, a ridge join, etc.

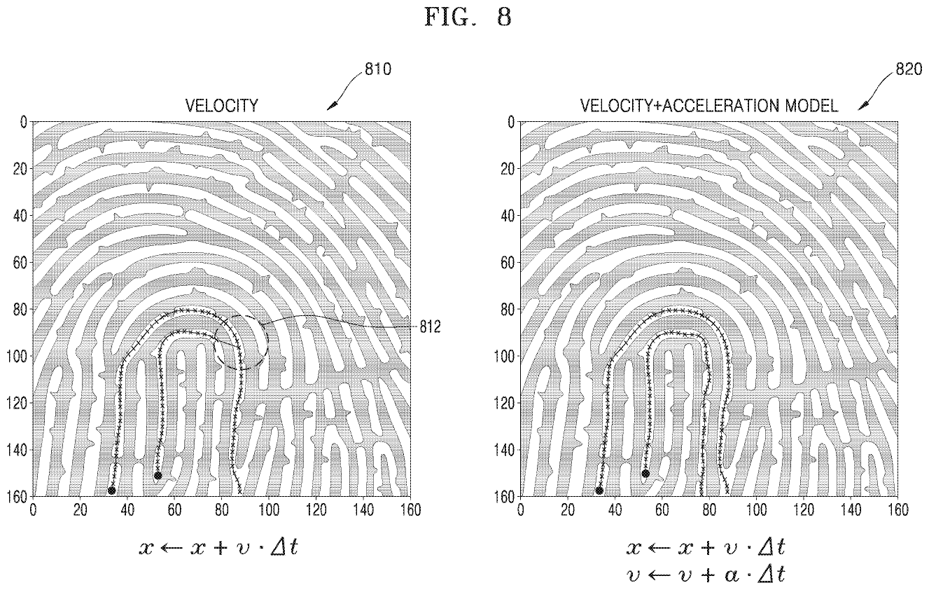

FIG. 8 is a diagram illustrating example motion state parameters used by an electronic device for fingerprint recognition according to various example embodiments.

In an embodiment of the disclosure, the electronic device 100 may use velocity and acceleration as motion state parameters. The electronic device 100 may track a ridge path in a fingerprint image using the motion state parameters.

Although detailed fingerprint features vary by individual, the ridges and valleys in a fingerprint generally include curves. In other words, a fingerprint includes various curves, and when the curvature of a curve is steep, an error may occur in predicting a next point of a ridge path.

A first example 810 of ridge path tracking illustrates the result of repeating, by the electronic device 100, the prediction of the next point of a ridge path using only velocity when tracking the ridge path. Referring to the first example 810, when the electronic device 100 tracks a ridge path by repeating the process of predicting a next point of a ridge path, a prediction error 812 may occur in which the predicted next point is predicted to be a point on another single ridge path, rather than a point on the current single ridge path. In other words, when the change in velocity is not reflected, the predicted point may deviate from the current ridge path being tracked in a sharp curvature section during next point prediction.

The electronic device 100 may apply acceleration at every point of the ridge path tracking and precisely track a single ridge including sharp curvatures by reflecting the change in velocity. A second example 820 of ridge path tracking illustrates the result of repeating, by the electronic device 100, the prediction of the next point of a ridge path using both velocity and acceleration when tracking the ridge path. Referring to the second example 820, even when there is a sharp curvature in a ridge, a result in which different ridges are identified as being distinguished from each other may be shown. The electronic device 100 may update the velocity using acceleration at every points and predict the next point using the velocity to identify each single ridge without deviating from the ridge path.

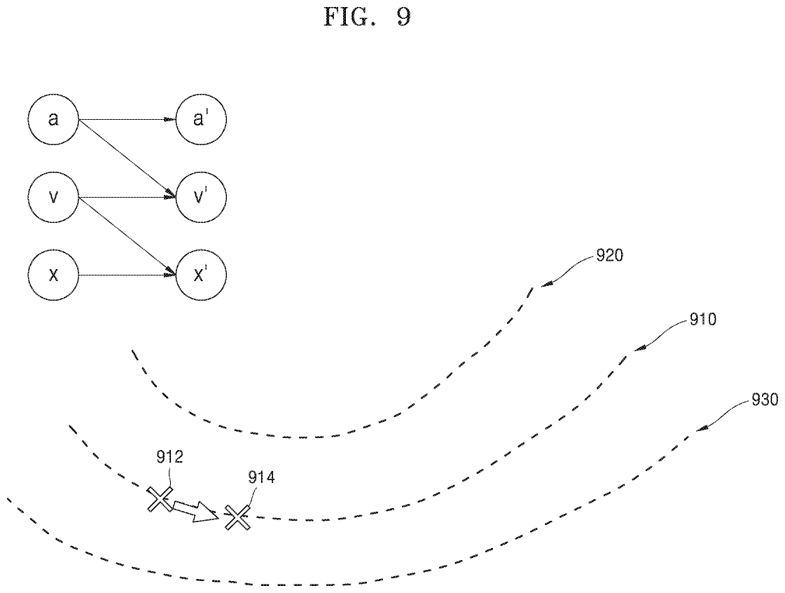

FIG. 9 is a diagram illustrating an example operation of tracking a ridge path by an electronic device according to various example embodiments.

The example illustrated in FIG. 9 corresponds to a case where the first condition and the second condition described in relation to FIG. 7 are satisfied when tracking a single ridge path.

In an embodiment of the disclosure, the electronic device 100 may identify single ridges (910, 920, and 930) included in a fingerprint using the fingerprint recognition model. The electronic device 100 may track a ridge path by repeating the process of predicting and adjusting points on a ridge path.

The electronic device 100 may update hidden parameters of the fingerprint recognition model at every points of the ridge path tracking. For example, the electronic device 100 may update the acceleration. For example, the electronic device 100 may update the velocity using the acceleration. For example, the electronic device 100 may update the position using the velocity.

For example, when the electronic device 100 identifies a first single ridge 910 in the fingerprint image, the electronic device 100 may predict a next point 914 based on a position, velocity, and acceleration of a current point 912 on a path of the first single ridge 910. After predicting the next point 914, the electronic device 100 may adjust the position of the next point 914 and update the position, velocity, and acceleration. The parameters updated at the next point 914 may be used in predicting a subsequent point. The electronic device 100 may identify the first single ridge 910 by repeating the process of predicting subsequent points of the ridge path, adjusting the positions thereof, and updating the parameters.

In the same manner, the electronic device 100 may identify other single ridges, e.g., a second single ridge 920, a third single ridge 930, . . . , an Nth single ridge, which are different from the first single ridge 910, to identify entire ridges included in the fingerprint image.

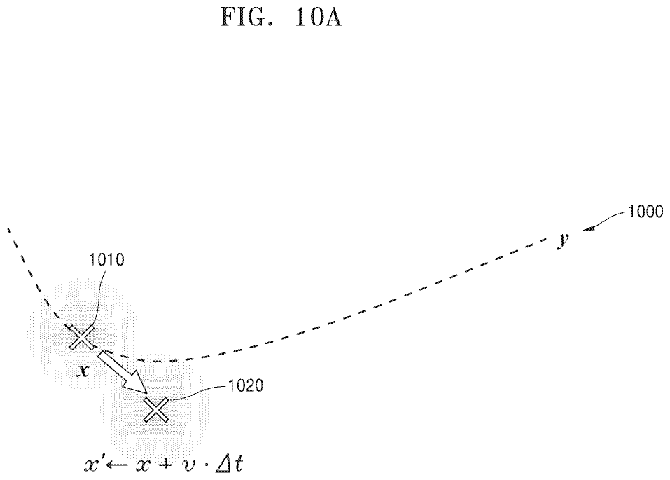

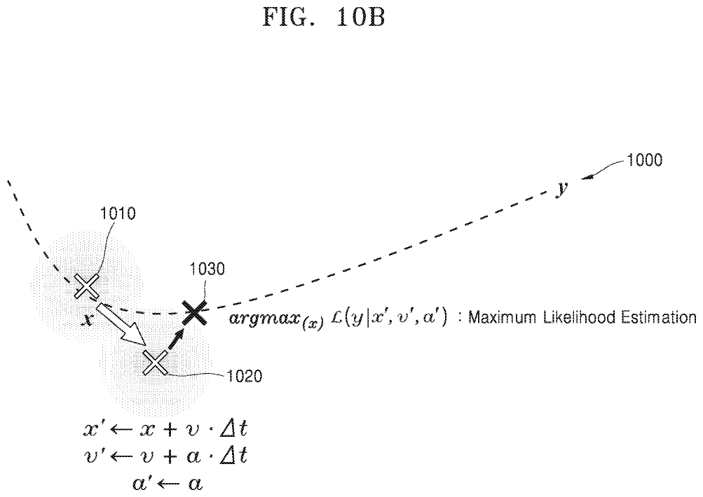

FIG. 10A is a diagram illustrating an example operation of predicting a point of a ridge path by an electronic device according to various example embodiments.

In describing FIG. 10A, for convenience, only one ridge 1000 is illustrated from among a plurality of ridges included in a fingerprint. In addition, FIG. 10A illustrates a state at a certain intermediate time point during a process in which the electronic device 100 tracks a ridge path starting from a start point. The operation illustrated in relation to FIG. 10A may correspond to operation 710 of FIG. 7.

In an embodiment of the disclosure, the electronic device 100 may predict a next point 1020 of a ridge path based on a position of a current point 1010 and motion state parameters. The prediction of the next point 1020 from the current point 1010 by the electronic device 100 may be calculated as follows:

x′←x+v Δt

Here, x′ represents a position of the predicted next point 1020, v represents a velocity at the current point 1010, and Δt represents a parameter for adjusting a prediction interval between points. The position of the current point 1010 and the motion state parameters may be updated after the current point 1010 has been predicted from a previous point. For example, the velocity at the current point 1010 may be updated based on the velocity and acceleration at the previous point.

In an embodiment of the disclosure, the electronic device 100 may adjust the parameter Δt for adjusting a prediction interval between points. By adjusting the parameter for adjusting a prediction interval between points, the electronic device 100 may adjust the trade-off between the prediction accuracy and efficiency. For example, as Δt decreases, the prediction interval between points becomes shorter, which may increase prediction accuracy, and as Δt increases, the prediction interval becomes larger, which may reduce the computational load.

Referring to FIG. 10A, the position of the predicted next point 1020 may be a point at a different position that is not on the path of the ridge 1000. The electronic device 100 may adjust the predicted next point 1020 such that the predicted next point 1020 corresponds to the ridge path. This is to be described in greater detail below with reference to FIG. 10B.

FIG. 10B is a diagram illustrating an example operation of inspecting and adjusting a predicted point of a ridge path by an electronic device according to various example embodiments.

In describing FIG. 10B, for convenience, only one ridge 1000 is illustrated from among a plurality of ridges included in a fingerprint. In addition, FIG. 10B illustrates the predicted next point 1020 in FIG. 10A (hereinafter, “predicted point 1020”) and a next point 1030 of which position has been adjusted (hereinafter, “adjusted point 1030”). The operation illustrated in relation to FIG. 10B may correspond to operations 720 and 725 of FIG. 7.

In an embodiment of the disclosure, the electronic device 100 may adjust the predicted point 1020. The electronic device 100 may find values of position, velocity, and acceleration, which are hidden parameters that yield the maximum likelihood value using the maximum likelihood estimation. For example, the electronic device 100 may calculate likelihood values for a search range within a predicted range from predicted points. The electronic device 100 may obtain the likelihood values by multiplying a Gaussian function corresponding to a point and pixel values of the fingerprint image, which are a set of observed data representing ridges.

For example, when the likelihood value is calculated based on the position of the predicted point 1020, as the pixel values, which are observed data, do not exist, the likelihood value may be relatively low. When the electronic device 100 calculates the likelihood values for the search range within the predetermined range, and then calculates the likelihood value based on the position of the adjusted point 1030, the likelihood value may be highest due to the presence of pixel values, which are observation data (operation 720 of FIG. 7).

In an embodiment of the disclosure, the electronic device 100 may determine whether to adjust the predicted point during the maximum likelihood estimation process. Determining whether to adjust the predicted point 1020 may refer, for example, to determining whether a ridge path exists, and when a ridge path does not exist, it is unnecessary to adjust the predicted point 1020. In other words, determining whether to adjust the predicted point 1020 may be determined based on a threshold value for determining whether a ridge path exists.

For example, the electronic device 100 may determine that an actual observation point (ridge pixel) of which position is to be adjusted exists around the predicted point 1020 when the likelihood value is greater than or equal to the threshold value. The electronic device 100 may determine that an actual observation point of which position is to be adjusted does not exist around the predicted point 1020 when the likelihood value is less than the threshold value.

In an embodiment of the disclosure, the electronic device 100 may adjust the threshold value, which is a parameter determining whether a ridge path exists. The electronic device 100 may adjust the trade-off between the ridge path tracking accuracy and efficiency by adjusting the parameter determining whether a ridge path exists. For example, when the threshold value decreases, even regions with low observed pixel values (e.g., ridges with low pixel intensities due to shallow finger contact) may be predicted as a ridge path, and when the threshold value increases, a ridge path may be determined only for regions with sufficiently high observed pixel values, enabling reliable ridge path prediction.

In an embodiment of the disclosure, the electronic device 100 may determine the radius of the Gaussian function for likelihood calculation. The radius of a Gaussian function may be adjusted by the variance, and the electronic device 100 may estimate the ridge thickness and adjust the variance of Gaussian function such that the radius of the Gaussian function corresponds to the ridge thickness. In an embodiment of the disclosure, the electronic device 100 may adjust the radius of the Gaussian function for likelihood calculation. The electronic device 100 may adjust the trade-off between the likelihood calculation accuracy and efficiency by adjusting the radius of the Gaussian function. For example, when the radius of the Gaussian function increases, the accuracy of likelihood calculation may also increase, and when the radius of the Gaussian function decreases, the computational load for the likelihood calculation may be reduced.

In an embodiment of the disclosure, the electronic device 100 may identify a point that maximizes/increases the likelihood value using the maximum likelihood estimation and finalize the adjusted point 1030 at the position. The electronic device 100 may determine the adjusted point 1030 by adjusting the position of the predicted point 1020 and update the hidden parameters (operation 725 of FIG. 7). The updating of the hidden parameters by the electronic device 100 may be calculated as follows:

x←x+v·Δt, v←v+α·Δt, α′←α

Here, x′ represents a position of the adjusted point 1030, Δt represents a parameter for adjusting a prediction interval between points, v′ represents an updated velocity, and a′ represents an updated acceleration.

In an embodiment of the disclosure, after determining the adjusted point 1030, the electronic device 100 may estimate a path of the ridge 1000 by performing estimation of a next point of the adjusted point. The process of repeating, by the electronic device 100, the prediction and adjustment of a next point for estimation of a path of the ridge 1000 may be performed until the defined conditions for determining an end point of a ridge path are satisfied.

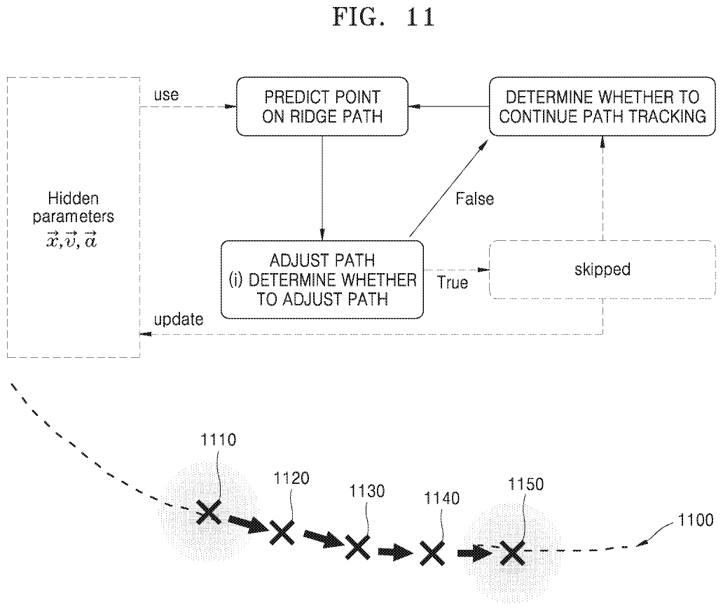

FIG. 11 is a diagram illustrating an example operation of predicting a point of a ridge path by an electronic device according to various example embodiments.

In describing FIG. 11, for convenience, only one ridge 1100 is illustrated from among a plurality of ridges included in a fingerprint. In addition, FIG. 11 illustrates states at a certain intermediate time point during a process in which the electronic device 100 tracks a ridge path starting from a start point. The operations described in relation to FIG. 11 correspond to the operations described above in relation to FIG. 7 and are to explain processing of exceptional cases that may occur during the ridge path tracking process. In other words, the example of FIG. 11 corresponds to a case in which the first condition described in relation to FIG. 7 is not satisfied, and the single ridge path is tracked through the operation according to the third condition.

In an embodiment of the disclosure, the quality of a fingerprint image obtained through a fingerprint sensor, etc. may be determined according to a state of a finger (e.g., a wet state, a dry state, etc.) For example, when fingerprint recognition is performed with a dry finger, degradation of fingerprint image quality may occur, such as partial ridge loss even though the ridges actually exist. In other words, there may be a region in the fingerprint image where pixel values corresponding to ridges are not obtained. The electronic device 100 may determine a region lacking pixel values as a ridge and generate a ridge path through the ridge estimation algorithm.

For example, the electronic device 100 may predict a second point 1120 from a first point 1110 during the ridge path tracking process. When the second point 1120 is predicted, the electronic device 100 may apply the maximum likelihood estimation for a search range within a predetermined range based on the predicted point to see whether the predicted point corresponds to an observed value. When the likelihood values calculated through the maximum likelihood estimation are less than the threshold value, the electronic device 100 may determine that an actual observation point is not identified around the predicted point. When an observed point corresponding to the predicted point is not identified, the electronic device 100 may skip the adjustment of a position of the predicted point. In this case, the electronic device 100 may examine the defined condition for determining an end point of the ridge path.

When the defined condition for determining an end point of the ridge path is not satisfied, the electronic device 100 may predict a third point 1130 from the second point 1120. When an observed point corresponding to the third point 1130 is not identified, the adjustment of a position of the third point 1130 may be skipped, and a fourth point 1140 may be predicted.

When the defined condition for determining an end point of the ridge path is not satisfied, the electronic device 100 may predict a fifth point 1150 from the fourth point 1140. In the example of FIG. 11, as a result of applying the maximum likelihood estimation based on the predicted fifth point 1150, pixel data, which is an observed value representing the ridge 1100 exists, and thus a point may be identified. When the point is identified, the electronic device 100 may adjust the position of the fifth point 1150 based on the maximum likelihood estimation and update hidden parameters, e.g., position, velocity, and acceleration.

By repeating the prediction and position adjustment of a next point, the electronic device 100 may skip the position adjustment of a next point and perform prediction of a subsequent point when an observed value of the next point is not identified. When an observed value of the point is identified during the prediction of the subsequent point, the electronic device 100 may adjust a position of the subsequent point and determine a ridge path including skipped points. In the example of FIG. 11, as a result of estimation of the ridge 1100, the ridge path may include the first point 1110, the second point 1120, the third point 1130, the fourth point 1140, and the fifth point 1150. In this regard, the first point 1110 and the fifth point 1150 are points of which positions have been adjusted after point identification, and the second point 1120, the third point 1130, and the fourth point 1140 are points for which position adjustment has been skipped due to point identification failure.

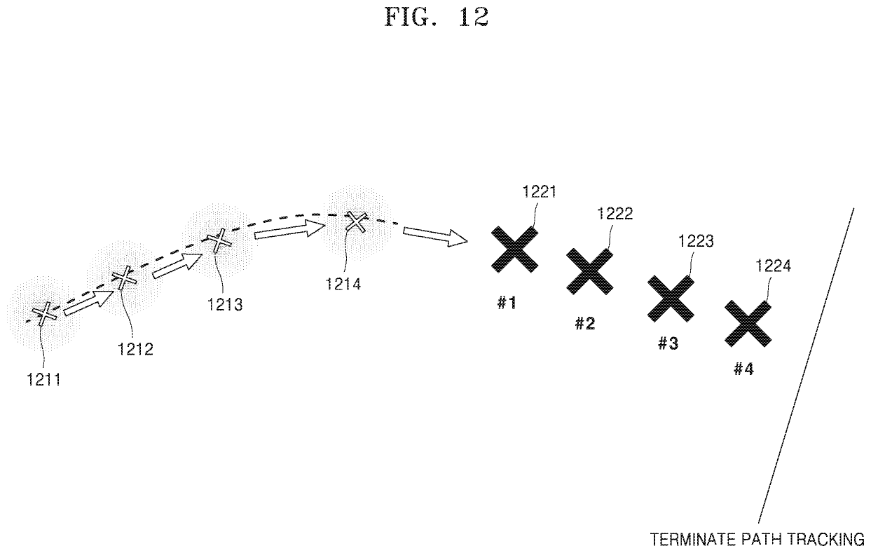

FIG. 12 is a diagram illustrating an example operation of determining an end point of a ridge path by an electronic device according to various example embodiments.

The example of FIG. 12 corresponds to a case in which the first condition described in relation to FIG. 7 is not satisfied, and the end point of the ridge is determined through the operation according to the third condition. In an embodiment of the disclosure, the electronic device 100 may determine the end point of the ridge path based on defined conditions. For example, the electronic device 100 may determine a point of which position is adjusted last as the end point of the ridge path when the number of points for which position adjustment has been skipped exceeds a threshold value.

The electronic device 100 may repeat the prediction and adjustment for points of the ridge path to identify a single ridge. For example, the electronic device 100 may determine a second point 1212 through a point prediction and adjustment process using a first point 1211 and a motion state vector, determine a third point 1213 through a point prediction and adjustment process using the second point 1212 and the motion state vector, and determine a fourth point 1214 through a point prediction and adjustment process using the third point and the motion state vector. In this manner, the electronic device 100 may perform prediction for a subsequent point using the fourth point 1214 and the motion state and obtain a predicted position of the subsequent point as a result.

When the point is predicted, the electronic device 100 may perform point identification to see whether the predicted point corresponds to the observed value. For example, the electronic device 100 may calculate likelihood values within the predetermined range from the predicted point using the maximum likelihood estimation and find values of position and motion state parameters (velocity and acceleration) that cause the position of the predicted point to correspond to the center of pixels representing a ridge. In this case, the electronic device 100 may find a point that has the maximum likelihood among likelihood values that are greater than or equal to a threshold value. However, when the likelihood values are less than the threshold value, the electronic device 100 may determine that a point is not identified and skip the position adjustment for the predicted point.

As a result, the electronic device 100 may determine a subsequent point of the fourth point 1214 as a first skipped point 1221. The position of the first skipped point 1221 may correspond to a position predicted based on the fourth point 1214. In the same manner, as a result of performing, by the electronic device 100, the prediction and adjustment for subsequent points after the first skipped point 1221, a second skipped point 1222, a third skipped point 1223, and a fourth skipped point 1224, for which position adjustment has been skipped due to failure of point identification, may be identified.

The failure to identify a point may occur in a case where pixel values are not measured in the fingerprint image even though the ridge actually exists due to poor fingerprint image quality, or in a case where the ridge actually ends. In the former case, when the point identification and position adjustment are performed again at a subsequent point, it may be determined that the ridge was missing in the fingerprint image, and the ridge path tracking may be continued (refer to FIG. 11). In the latter case, when the number of points for which position adjustment has been skipped exceeds a threshold value, it may be determined to be the end point of the ridge. For example, as illustrated in FIG. 12, when the threshold value is 3, and the number of points for which position adjustment has been skipped exceeds 3, the electronic device 100 may determine the fourth point 1214 which is the last adjusted point, as an end point of the ridge path. Although FIG. 12 describes that the threshold value of the skipped point for determining an end point of a ridge path is 3, this is merely an example.

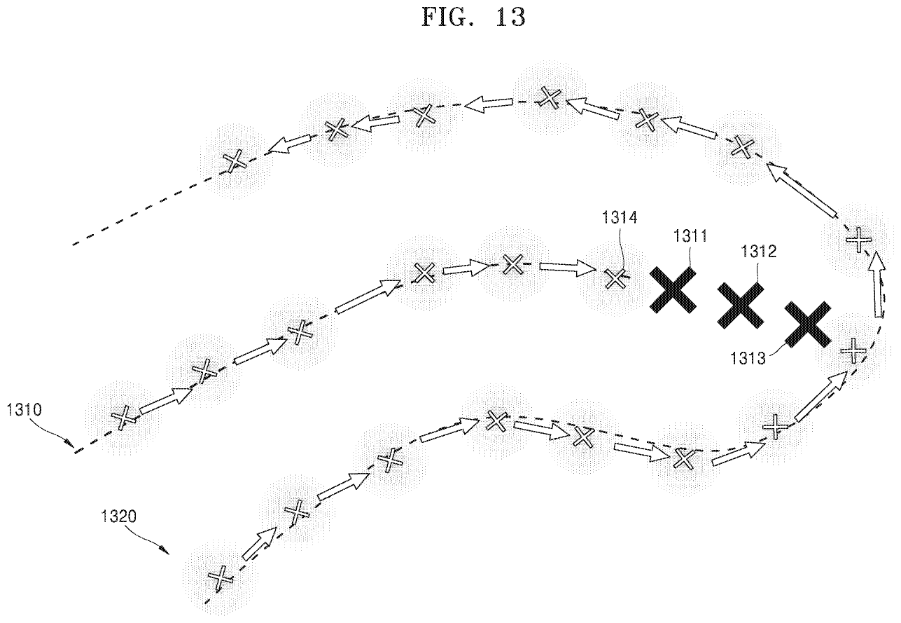

FIG. 13 is a diagram illustrating an example operation of determining an end point of a ridge path by an electronic device according to various example embodiments.

The example of FIG. 13 corresponds to a case in which the first condition described in relation to FIG. 7 is not satisfied, and the end point of the ridge is determined according to the second condition after operation according to the third condition. In an embodiment of the disclosure, the electronic device 100 may determine the end point of the ridge path based on defined conditions.

The electronic device 100 may repeat the prediction and adjustment for points of the ridge path to identify a single ridge. When a next point is not identified during the repetitive process of prediction and adjustment for points of the ridge path, the electronic device 100 may skip the position adjustment for the next point and perform prediction and adjustment for a subsequent point of the skipped point.

For example, in the process of repeating, by the electronic device 100, the point prediction and adjustment for a first single ridge 1310, a first skipped point 1311, a second skipped point 1312, and a third skipped point 1313 may be identified. In this case, when the electronic device 100 performs prediction for a subsequent point of the third skipped point 1313, a point on another single ridge, for example, a second single ridge 1320 instead of the first single ridge 1310 may be identified as a result of the point identification. Then, the electronic device 100 may determine a point of which position has been adjusted prior to the first skipped point 1311 as an end point of the first single ridge 1310.

For example, the electronic device 100 may determine a point of which position is adjusted last as the end point of the ridge path when an angle between the ridge path including a connection line of the point for which position adjustment has been skipped and a ridge path of another single ridge exceeds a threshold value. For example, when an angle between the path of the first single ridge 1310 including a connection line of the first skipped point 1311, the second skipped point 1312, and the third skipped point 1313 and a path of the second single ridge 1320 exceeds a threshold value, the electronic device 100 may determine the last adjusted point 1314 as an end point of the first single ridge 1310. The electronic device 100 may determine an end point of a single ridge using a motion state vector. As the motion state vector of the first single ridge 1310 and the motion state vector of the second single ridge 1320 have different directions from each other, when an angle between the directions of the two vectors exceeds a threshold value, the electronic device 100 may determine the last adjusted point 1314 as an end point of the first single ridge 1310.

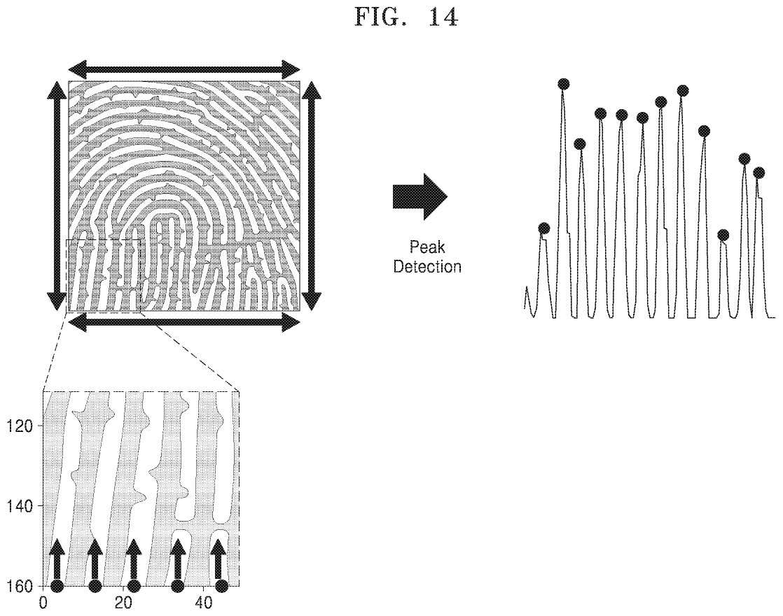

FIG. 14 is a diagram illustrating an example operation of determining start points for tracking a ridge path by an electronic device according to various example embodiments.

In an embodiment of the disclosure, the electronic device 100 may determine one or more start points in the fingerprint image, to which the ridge estimation algorithm is to be applied. The electronic device 100 may identify a single ridge included in the fingerprint image by repeating point prediction and adjustment using the ridge estimation algorithm, starting from each start point. The electronic device 100 may identify a plurality of ridges in the fingerprint image by repeating the process of identifying each single ridge using the ridge estimation algorithm.

The electronic device 100 may obtain a fingerprint image. The electronic device 100 may perform peak detection on edges of the fingerprint image. For example, the electronic device 100 may scan and store a pixel value of each of an upper edge, a lower edge, a left edge, and a right edge of the fingerprint image and detect a peak representing a portion where a pixel intensity changes significantly at each edge. The electronic device 100 may identify coordinates of detected peaks for each edge in the fingerprint image and determine the identified coordinates as start points for ridge path tracking.

The electronic device 100 may track a ridge path, starting from each start point. For example, the electronic device 100 may identify single ridges leading from each start point by performing ridge path tracking in a direction perpendicular to each edge, starting from an initial start point. Initial motion state parameters (velocity and acceleration) for ridge path tracking may have defined values or arbitrary values. During the ridge path tracking by the electronic device 100, the motion state parameters may be updated at each point by the fingerprint recognition model using the ridge estimation algorithm.

In an embodiment of the disclosure, the electronic device 100 may select a point in the fingerprint image to determine one or more start points instead of determining a start point at the edges of the fingerprint image. For example, the electronic device 100 may determine N start points in the fingerprint image. In this case, even when an initial start point does not correspond to a pixel of a ridge, the point may be adjusted to correspond to a pixel of the ridge through point prediction and adjustment of the ridge estimation algorithm. When a start point is determined at an arbitrary position rather than at the edges of the fingerprint image, the electronic device 100 may track a ridge path in both directions from the start point and determine single ridges to identify a plurality of ridges.

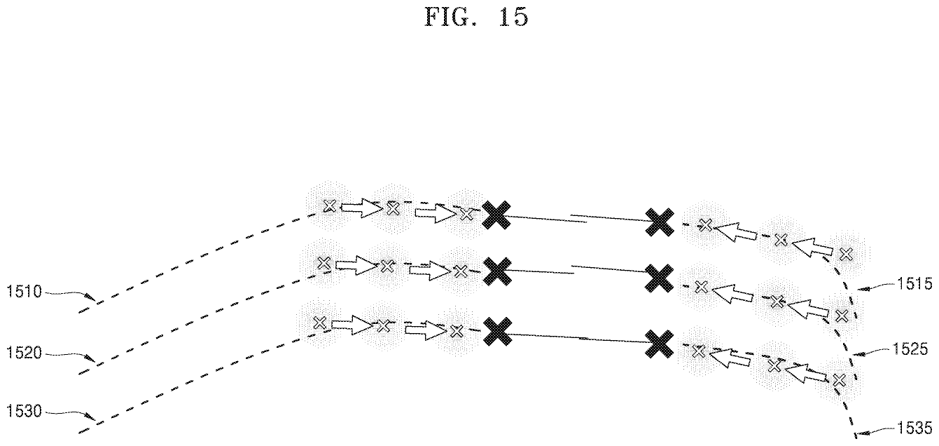

FIG. 15 is a diagram illustrating an example operation of optimizing a connection between ridges by an electronic device according to various example embodiments.

In an embodiment of the disclosure, the electronic device 100 repeat the single ridge identification through the ridge estimation algorithm and then optimize a connection between the ridges using the maximum likelihood estimation. The electronic device 100 may estimate an extension direction of a most likely line from among the estimated single ridges using the maximum likelihood estimation.

For example, upon performing single ridge identification by the electronic device 100, the identification result may show a first ridge B 1515 of a first ridge A 1510. The electronic device 100 may generate a probabilistic model for a disconnected portion of the first ridge A 1510 based on a ridge path, curvature, direction, and end point of the first ridge A 1510. The electronic device 100 may estimate a direction in which a disconnected portion of the first ridge A 1510 is to be connected and find a most likely direction through maximum likelihood estimation by modeling direction data using a Gaussian distribution. In this case, the first ridge B 1515 may be used as an observed value, and the likelihood that the first ridge A 1510 is to be connected with the first ridge B 1515 may be evaluated. However, the foregoing is merely as example. Using the first ridge A 1510 as an observed value, the maximum likelihood estimation may be used to find a ridge with a high likelihood of being connected to the first ridge B 1515, or the maximum likelihood estimation may be applied to every single ridges.

The electronic device 100 may find a single ridge having a high likelihood of connection using the maximum likelihood estimation, and when single ridges with high connection likelihood are identified, the electronic device 100 may perform optimization to connect the ridges through pixel interpolation. In the example of FIG. 15, as a result of optimization of ridge connection performed by the electronic device 100, a first single ridge A 1510 may be connected to a first single ridge B 1515, a second single ridge A 1520 may be connected to a second single ridge B 1525, and a third single ridge A 1530 may be connected to a third single ridge B 1535.

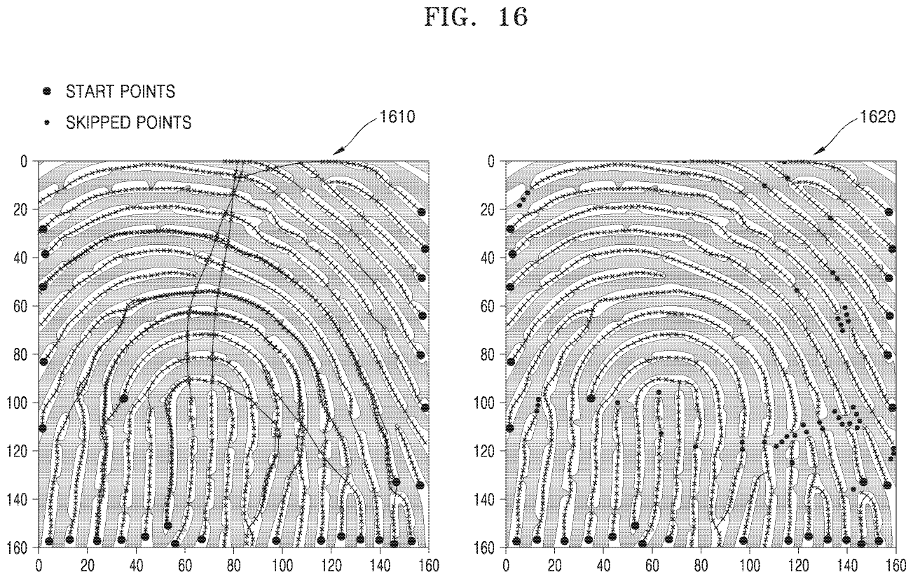

FIG. 16 is a diagram illustrating an example operation of optimizing a connection between ridges by an electronic device according to an embodiment of the disclosure.

Referring to FIG. 16, a first example 1610 shows a result of performing only point prediction and position adjustment of ridge paths from a plurality of start points, without determining ridge path end points and optimizing connections between ridges. Referring to the first example 1610, in the process of tracking each ridge in the fingerprint image, some ridge paths may deviate, or a path that is not actually a ridge may be determined to be a ridge.

The electronic device 100 may obtain fingerprint information by precisely identifying a plurality of ridges through determination of ridge path end point and optimization of ridge connections. Referring to a second example 1620, the electronic device 100 may prevent or reduce abnormal extension of single ridge by determining an end point of a ridge based on defined conditions. For example, when tracking a single ridge, the electronic device 100 may terminate the ridge path tracking by determining an end point of a single ridge path when the number of points for which position adjustment has been skipped exceeds a threshold value (e.g., 2). When tracking a single ridge, the electronic device 100 may terminate the ridge path tracking by determining an end point of a single ridge path when an angle between a ridge path including a connection line of a point for which position adjustment has been skipped and another single ridge path exceeds a threshold value. After all ridges are identified by repeating the identification of single ridge, the electronic device 100 may optimize connections between the ridges such that single ridges with high likelihood for connection may be additionally connected. Accordingly, the second example 1620 may show a result in which ridges in the fingerprint image are identified more accurately than in the first example 1610.

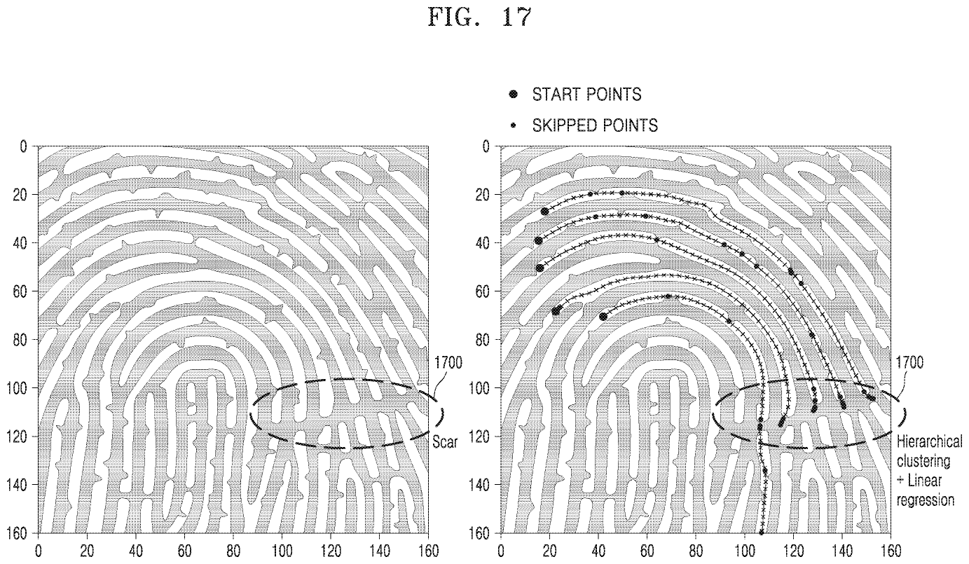

FIG. 17 is a diagram illustrating an example operation of estimating a fingerprint scar by an electronic device according to various example embodiments.

In an embodiment of the disclosure, the electronic device 100 may estimate a scar 1700 of a fingerprint. The scar 1700 of a fingerprint may refer to a pattern forming fingerprint information in a form different from a ridge within the fingerprint. For example, the scar 1700 may refer to a pattern generated by temporary or permanent skin damage. Apart from the skin damage, the scar 1700 may include patterns such as fine creases or folds occurring in areas where the finger is frequently bent or under pressure.

After repeating the identification of single ridge through the ridge estimation algorithm, the electronic device 100 may identify points for which position adjustment has been skipped. For example, the electronic device 100 may identify a region in which skipped points are concentrated in the fingerprint image using hierarchical clustering. The electronic device 100 may group skipped points within an adjacent distance into a cluster by measuring a distance (e.g., Euclidean distance) between the skipped points.

The electronic device 100 may estimate the scar 1700 of the fingerprint based on the cluster including the points for which position adjustment has been skipped. For example, the electronic device 100 may perform linear regression for the cluster including the skipped points identified via hierarchical clustering. The electronic device 100 may obtain a regression line for the cluster to obtain a line representing the distribution of the skipped points. The electronic device 100 may determine a line identified by linear regression as the scar 1700. The scar 1700 may include one or more scars.

In an embodiment of the disclosure, the electronic device 100 may include the identified scar 1700 in the fingerprint information. For example, the electronic device 100 may generate the fingerprint information including a bifurcation, an ending, etc. based on a plurality of ridges. In this case, a line representing the scar 1700 may be included in the fingerprint information.

In an embodiment of the disclosure, the electronic device 100 may store a fingerprint from which the identified scar 1700 is removed as the fingerprint information. For example, the electronic device 100 may remove the identified scar 1700, reconnect the broken ridges for restoration, and generate fingerprint information including bifurcation, endings, etc. based on the restored ridges.

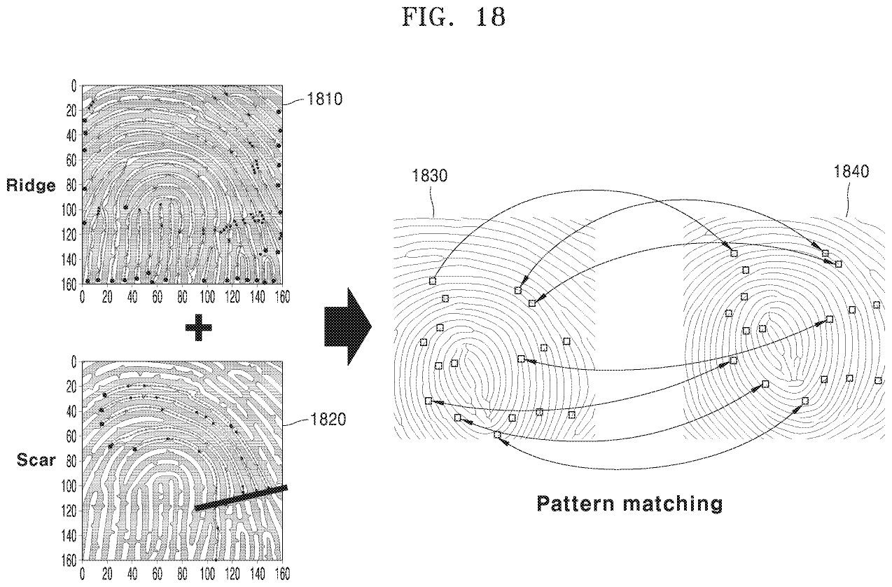

FIG. 18 is a diagram illustrating an example operation of performing fingerprint recognition by an electronic device according to various example embodiments.

In an embodiment of the disclosure, the electronic device 100 may perform fingerprint recognition by generating the fingerprint information based on the fingerprint image. The fingerprint recognition process may include performing biometric authentication based on the obtained fingerprint image.

The electronic device 100 may identify ridges 1810 of a fingerprint by tracking ridge paths from one or more start points in the fingerprint image using the ridge estimation algorithm with respect to the fingerprint image. In addition, the electronic device 100 may identify a scar 1820 of a fingerprint based on a cluster of skipped points identified during the process of the ridge estimation algorithm. The electronic device 100 may obtain fingerprint information 1830 for fingerprint recognition based on the ridges 1810 and the scar 1820. The fingerprint information 1830 may be minutiae including specific characteristics of a fingerprint. The minutiae may include, for example, a bifurcation at which one ridge divides into two branches, an ending at which a ridge ends, etc. However, the disclosure is not limited thereto, and the minutiae may also include a scar, an island, a pore, a crossing, a ridge join, etc.

In an embodiment of the disclosure, the electronic device 100 may perform biometric authentication by comparing the fingerprint information 1830 with fingerprint authentication information 1840. The fingerprint authentication information 1840 may be information for biometric authentication which is pre-registered by a user of the electronic device 100 and stored in the electronic device 100. The electronic device 100 may perform pattern matching between the fingerprint information 1830 and the fingerprint authentication information 1840 and determine whether the fingerprint information 1830 corresponds to the fingerprint authentication information 1840. When the fingerprint information 1830 corresponds to the fingerprint authentication information 1840, the electronic device 100 may finish the biometric authentication and perform functions that can be provided after authentication (e.g., unlocking, secure file access, payment, financial services, etc.)

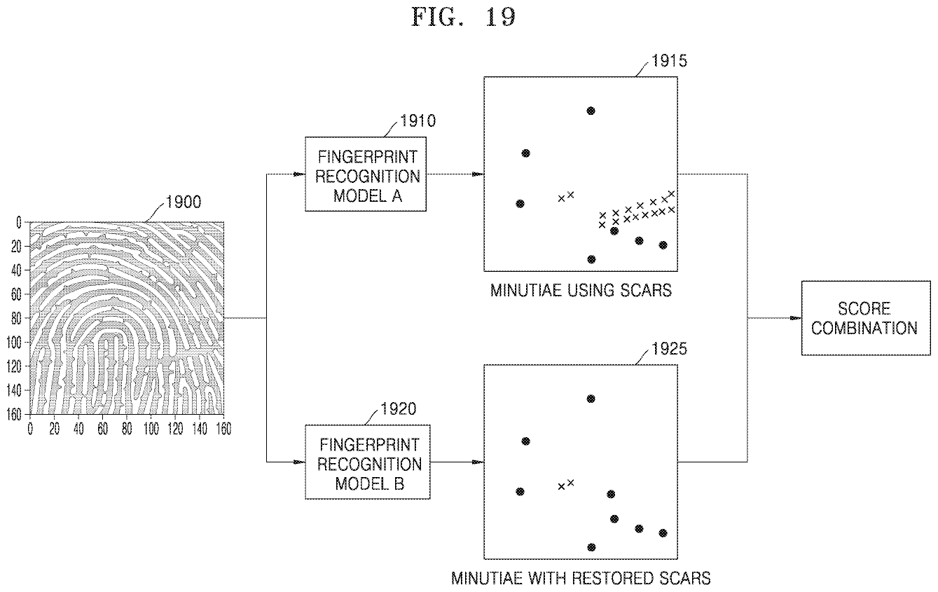

FIG. 19 is a diagram illustrating an example operation of performing fingerprint recognition by an electronic device according to various example embodiments.

In an embodiment of the disclosure, the electronic device 100 may perform fingerprint recognition using a plurality of fingerprint recognition models. For example, the electronic device 100 may use a first fingerprint recognition model (e.g., a fingerprint recognition model A 1910) and a second fingerprint recognition model (e.g., a fingerprint recognition model B 1920).

The fingerprint recognition model A 1910 may be a model receiving a fingerprint image 1900 and outputting fingerprint information 1915 including scars. The fingerprint recognition model A 1910 may be a model trained using the fingerprint information 1915 including scars as training data. The fingerprint recognition model A 1910 may estimate ridges of a fingerprint by tracking ridge paths from one or more start points in the fingerprint image 1900. The tracking of ridge paths of a fingerprint may include repeating the process of tracking a ridge path of a single ridge. The estimating of a ridge path of a single path may include repeating the process of predicting and adjusting a next point of a ridge path. In this case, when a next point is not identified, the position adjustment may be skipped, and prediction of a subsequent point may be performed. The fingerprint recognition model A 1910 may obtain scar information of a fingerprint based on skipped points identified during the ridge path tracking process.

The fingerprint recognition model B 1920 may be a model receiving the fingerprint image 1900 and outputting fingerprint information 1925 in which scars have been restored. The fingerprint recognition model B 1920 may be a model trained using the fingerprint information 1925 in which scars have been restored (or fingerprint information without scars) as training data. The fingerprint recognition model B 1920 may estimate ridges of a fingerprint by tracking ridge paths from one or more start points in the fingerprint image 1900. The tracking of ridge paths of a fingerprint may include repeating the process of tracking a ridge path of a single ridge. The estimating of a ridge path of a single path may include repeating the process of predicting and adjusting a next point of a ridge path. In this case, when a next point is not identified, the position adjustment may be skipped, and prediction of a subsequent point may be performed. The fingerprint recognition model B 1920 may obtain scar information of a fingerprint based on skipped points identified during the ridge path tracking process. When the scar information is identified, the fingerprint recognition model B 1920 may obtain the fingerprint information 1925 in which scars have been restored.

In the fingerprint recognition model A 1910, due to the scar information included in the fingerprint information, detailed features within fingerprint information may increase, and accordingly, the fingerprint recognition rate for fingerprints including scars may be improved. However, as the scars are included in the fingerprint information, when a forged scar created by attaching a sticker to a finger is included, there may be a possibility that false recognition of a fingerprint may occur. Accordingly, to secure the recognition performance of fingerprints including scars while reducing cases of false recognition, the electronic device 100 may perform fingerprint recognition by combining results from a plurality of fingerprint recognition models. For example, when one fingerprint image 1900 is input, the electronic device 100 may perform biometric authentication by combining results from different fingerprint recognition models. For example, the electronic device 100 may obtain the fingerprint information 1915 including scars by inputting the fingerprint image 1900 to the fingerprint recognition model A 1910 and compare the fingerprint information 1915 including scars with fingerprint authentication information pre-stored in the electronic device 100 to calculate a first score representing a degree of pattern matching. The electronic device 100 may obtain the fingerprint information 1925 in which scars have been restored by inputting the fingerprint image 1900 to the fingerprint recognition model B 1920 and compare the fingerprint information 1925 in which scars have been restored with the fingerprint authentication information pre-stored in the electronic device 100 to calculate a second score representing a degree of pattern matching. The electronic device 100 may combine the first score and the second score using an ensemble method. For example, the electronic device 100 may calculate a final score for fingerprint authentication using an average of the first score and the second score or a weighted average of the first score and the second score. When the final score for fingerprint authentication is greater than or equal to a threshold value, the electronic device 100 may determine that the biometric authentication is successful.

The disclosure relates to a method of performing fingerprint recognition by robustly generating fingerprint information from a fingerprint image regardless of the state of a finger and an electronic device configured to perform the method. The technical objects to be achieved by the disclosure are not limited to the above, and other objects which are not mentioned herein can be clearly understood from the description by a person skilled in the art.

According to an example embodiment of the disclosure, provided is a fingerprint recognition method performed by an electronic device.

The method may include obtaining a fingerprint image.

The method may include estimating ridges of a fingerprint represented by the fingerprint image by tracking ridge paths from one or more start points within the fingerprint image through a ridge estimation algorithm.

The method may include obtaining fingerprint information for fingerprint recognition based on the estimated ridges.

For each of the ridges of the fingerprint, the ridge estimation algorithm may perform predicting a next point of a ridge path based on a current point and motion state parameters, adjusting the predicted next point and updating the motion state parameters based on the predicted next point and pixel values of the fingerprint image, and identifying a single ridge by tracking the ridge path through repeated prediction and adjustment of subsequent points of the ridge path.

The motion state parameters may include velocity and acceleration.

The adjusting of the predicted next point and updating the motion state parameters may include updating the motion state parameters through maximum likelihood estimation and adjusting a position of the predicted next point to correspond to a pixel within the ridge path.

The adjusting of the predicted next point and updating the motion state parameters may include skipping the adjusting of the position of the predicted next point when likelihood values calculated during the maximum likelihood estimation are less than a threshold value.

The identifying of the single ridge may include performing prediction and adjustment for a subsequent point of the point for which position adjustment has been skipped.

The identifying of the single ridge may include determining an end point of the ridge path based on a defined condition.

The determining of the end point of the ridge path may include determining a point of which position has been adjusted last as the end point of the ridge path when a number of points for which position adjustment has been skipped exceeds a threshold value.

The determining of the end point of the ridge path may include determining a point of which position has been adjusted last as the end point of the ridge path when an angle between the ridge path including a connection line of the point for which position adjustment has been skipped and a ridge path of another single ridge exceeds a threshold value.

The method may further include estimating an average thickness of the ridges from the fingerprint image.

The method may further include determining a Gaussian distribution function used in the maximum likelihood estimation for updating the motion state parameters based on the average thickness of the ridges.

The estimating of the ridges may include optimizing connections between the ridges by applying maximum likelihood estimation, after repeating identification of the single ridge through the ridge estimation algorithm.

The method may further include estimating a scar of the fingerprint based on a cluster including the points for which position adjustment has been skipped through the ridge estimation algorithm.

The method may further include performing fingerprint recognition based on the fingerprint information and pre-stored fingerprint authentication information.

According to an example embodiment of the disclosure, provided is an electronic device configured to perform fingerprint recognition. The electronic device includes at least one processor, comprising processing circuitry, memory storing instructions, and a display.

The instructions, when executed by at least one processor, individually or in any combination, may cause the electronic device to obtain a fingerprint image.

The instructions, when executed by at least one processor, individually or in any combination may cause the electronic device to estimate ridges of a fingerprint represented by the fingerprint image by tracking ridge paths from one or more start points within the fingerprint image through a ridge estimation algorithm.

The instructions, when executed by at least one processor, individually or in any combination, may cause the electronic device to obtain fingerprint information for fingerprint recognition based on the estimated ridges.

For each of the ridges of the fingerprint, the ridge estimation algorithm may perform predicting a next point of a ridge path based on a current point and motion state parameters, adjusting the predicted next point and updating the motion state parameters based on the predicted next point and pixel values of the fingerprint image, and identifying a single ridge by tracking the ridge path through repeated prediction and adjustment of subsequent points of the ridge path.

The instructions, when executed by at least one processor, individually and/or in any combination, may cause the electronic device to control the display to display a fingerprint recognition result based on the fingerprint information.

The motion state parameters may include velocity and acceleration.

The instructions, when executed by at least one processor, individually or in any combination, may cause the electronic device to update the motion state parameters through maximum likelihood estimation and adjust a position of the predicted next point to correspond to a pixel within the ridge path.

The instructions, when executed by at least one processor, individually or in any combination, may cause the electronic device to skip the adjusting of the position of the predicted next point when likelihood values calculated during the maximum likelihood estimation are less than a threshold value.

The instructions, when executed by at least one processor, individually or in any combination, may cause the electronic device to perform prediction and adjustment for a subsequent point of the point for which position adjustment has been skipped.

The instructions, when executed by at least one processor, individually or in any combination, may cause the electronic device to determine an end point of the ridge path based on a defined condition.

The instructions, when executed by at least one processor, individually or in any combination, may cause the electronic device to determine a point of which position has been adjusted last as the end point of the ridge path when a number of points for which position adjustment has been skipped exceeds a threshold value.

The instructions, when executed by at least one processor, individually or in any combination, may cause the electronic device to determine a point of which position has been adjusted last as the end point of the ridge path when an angle between the ridge path including a connection line of the point for which position adjustment has been skipped and a ridge path of another single ridge exceeds a threshold value.

The instructions, when executed by at least one processor, individually or in any combination, may cause the electronic device to determine a Gaussian distribution function used in the maximum likelihood estimation for updating the motion state parameters, based on an average thickness of the ridges.

The instructions, when executed by at least one processor, individually or in any combination, may cause the electronic device to optimize connections between the ridges by applying maximum likelihood estimation, after repeating identification of the single ridge through the ridge estimation algorithm.

The instructions, when executed by at least one processor, individually or in any combination, may cause the electronic device to estimate a scar of the fingerprint based on a cluster including the points for which position adjustment has been skipped through the ridge estimation algorithm.

The instructions, when executed by at least one processor, individually or in any combination, may cause the electronic device to perform fingerprint recognition based on the fingerprint information and pre-stored fingerprint authentication information.

Embodiments of the disclosure may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. Further, the computer-readable recording media may include both of computer storage media and communication media. The computer storage medium includes all of volatile and nonvolatile media, and removable and non-removable media implemented by any method or technology for storage of information such as computer-readable instructions, data structures, program modules, or other data. The communication medium may typically include data of modified data signals, such as computer-readable instructions, a data structure, or a program model.

The computer-readable storage medium may be provided in the form of a non-transitory storage medium. The non-transitory storage medium is tangible and may not include signals (e.g., electromagnetic waves), and this term is not intended to distinguish semi-permanent storage of data in a storage medium from temporary storage of the same. For example, the non-transitory storage may include a buffer in which data is temporarily stored.

According to an embodiment of the disclosure, the method described in one or more embodiments of the disclosure may be included and provided in a computer program product. A computer program product may be traded between a seller and a buyer. The computer program may be distributed in the form of a machine-readable storage medium (e.g., compact disc read-only memory; CD-ROM), or distributed (e.g., downloaded or uploaded) online through an application store or directly between two user devices (e.g., smartphones). In the case of online distribution, at least some of the computer program products (e.g., a downloadable application, etc.) may be at least temporarily stored in a storage medium readable by devices, such as memory of a manufacturer server, an application store server, or a relay server or temporarily generated.

The above descriptions of the disclosure are provided merely as an example, and one skilled in the art to which the disclosure pertains may understand that the disclosure can be easily modified into other specific forms without changing technical ideas or essential technical features of the disclosure. Therefore, it should be understood that the various embodiments described above are provided as examples in all aspects, and thus do not pose a limitation on the disclosure. For example, each component described as a single type component may be implemented in a dispersed manner, and similarly to this, components described as being dispersed may be implemented in an integrated manner.

The scope of the disclosure is defined not limited by the detailed description of the disclosure and includes the appended claims, and may be construed as encompassing all modifications or adaptions derived from the meaning and scope of the claims and their equivalent concepts.

It will also be understood that any of the embodiment(s) described herein may be used in conjunction with any other embodiment(s) described herein.

What is claimed is:

1. A fingerprint recognition method performed by an electronic device, the method comprising:
obtaining a fingerprint image;
estimating ridges of a fingerprint of the fingerprint image, by tracking ridge paths from one or more start points within the fingerprint image through a ridge estimation algorithm; and
obtaining fingerprint information for fingerprint recognition, based on the estimated ridges,
wherein, for each of the ridges of the fingerprint, the ridge estimation algorithm performs:
predicting a next point of a ridge path, based on a current point and motion state parameters;
adjusting the predicted next point and updating the motion state parameters, based on the predicted next point and pixel values of the fingerprint image; and
identifying a single ridge by tracking the ridge path through repeated prediction and adjustment of subsequent points of the ridge path.

2. The method of claim 1, wherein the motion state parameters include velocity and acceleration, and
the adjusting of the predicted next point and the updating of the motion state parameters comprise updating the motion state parameters through maximum likelihood estimation and adjusting a position of the predicted next point to correspond to a pixel within the ridge path.

3. The method of claim 2, wherein the adjusting of the predicted next point and the updating of the motion state parameters comprise skipping the adjusting of the position of the predicted next point based on likelihood values calculated during the maximum likelihood estimation being less than a threshold value, and
the identifying of the single ridge comprises performing prediction and adjustment for a subsequent point of the point for which position adjustment has been skipped.

4. The method of claim 3, wherein the identifying of the single ridge comprises determining an end point of the ridge path, based on a defined condition.

5. The method of claim 4, wherein the determining of the end point of the ridge path comprises determining a point of which a position has been adjusted last as the end point of the ridge path based on a number of points for which position adjustment has been skipped exceeding a threshold value.

6. The method of claim 4, wherein the determining of the end point of the ridge path comprises determining a point of which a position has been adjusted last as the end point of the ridge path based on an angle between the ridge path including a connection line of the point for which position adjustment has been skipped and a ridge path of another single ridge exceeding a threshold value.

7. The method of claim 2, further comprising:
estimating an average thickness of the ridges from the fingerprint image; and
based on the average thickness of the ridges, determining a Gaussian distribution function used in the maximum likelihood estimation to update the motion state parameters.

8. The method of claim 1, wherein the estimating of the ridges comprises optimizing connections between the ridges by applying maximum likelihood estimation, after repeating identification of the single ridge through the ridge estimation algorithm.

9. The method of claim 3, further comprising estimating a scar of the fingerprint, based on a cluster including the points for which position adjustment has been skipped, through the ridge estimation algorithm.

10. The method of claim 1, further comprising performing fingerprint recognition, based on the fingerprint information and stored fingerprint authentication information.

11. An electronic device configured to perform fingerprint recognition, the electronic device comprising:
at least one processor, comprising processing circuitry;
memory storing instructions; and
a display,
wherein the instructions, when executed by at least one processor, individually or in any combination, cause the electronic device to:
obtain a fingerprint image;
estimate ridges of a fingerprint of the fingerprint image, by tracking ridge paths from one or more start points within the fingerprint image through a ridge estimation algorithm; and
obtain fingerprint information for fingerprint recognition, based on the estimated ridges, and
wherein, for each of the ridges of the fingerprint, the ridge estimation algorithm performs:
predicting a next point of a ridge path, based on a current point and motion state parameters;
adjusting the predicted next point and updating the motion state parameters, based on the predicted next point and pixel values of the fingerprint image; and
identifying a single ridge by tracking the ridge path through repeated prediction and adjustment of subsequent points of the ridge path.

12. The electronic device of claim 11, wherein the motion state parameters include velocity and acceleration, and
the instructions, when executed by at least one processor, individually or in any combination, cause the electronic device to update the motion state parameters through maximum likelihood estimation and adjust a position of the predicted next point to correspond to a pixel within the ridge path.

13. The electronic device of claim 12, wherein the instructions, when executed by at least one processor, individually or in any combination, cause the electronic device to skip the adjusting of the position of the predicted next point based on likelihood values calculated during the maximum likelihood estimation being less than a threshold value, and perform prediction and adjustment for a subsequent point of the point for which position adjustment has been skipped.

14. The electronic device of claim 13, wherein the instructions, when executed by at least one processor, individually or in any combination, cause the electronic device to determine an end point of the ridge path, based on a defined condition.

15. The electronic device of claim 14, wherein the instructions, when executed by at least one processor, individually or in any combination, cause the electronic device to determine a point of which a position has been adjusted last as the end point of the ridge path based on a number of points for which position adjustment has been skipped exceeding a threshold value.

16. The electronic device of claim 14, wherein the instructions, when executed by at least one processor, individually or in any combination, cause the electronic device to determine a point of which a position has been adjusted last as the end point of the ridge path based on an angle between the ridge path including a connection line of the point for which position adjustment has been skipped and a ridge path of another single ridge exceeding a threshold value.

17. The electronic device of claim 12, wherein the instructions, when executed by the at least one processor, individually or in any combination, cause the electronic device to, based on an average thickness of the ridges, determine a Gaussian distribution function used in the maximum likelihood estimation to update the motion state parameters.

18. The electronic device of claim 11, wherein the instructions, when executed by at least one processor, individually or in any combination, cause the electronic device to optimize connections between the ridges by applying maximum likelihood estimation, after repeating identification of the single ridge through the ridge estimation algorithm.

19. The electronic device of claim 13, wherein the instructions, when executed by at least one processor, individually or in any combination, cause the electronic device to estimate a scar of the fingerprint, based on a cluster including the points for which position adjustment has been skipped, through the ridge estimation algorithm.

20. A non-transitory computer-readable recording medium having recorded thereon a program for executing the method of claim 1, on a computer.
